(19) United States
(12) Patent Application Publication
(10) Pub. No.: US 2022/0029309 A1
(43) Pub. Date: Jan. 27, 2022

(54) DUAL POLARISED PLANAR ANTENNA, BASE STATION AND METHOD OF MANUFACTURE

(71) Applicant: The Secretary of State for Defence, Salisbury, Wiltshire (GB)

(72) Inventors: Stephen John Boyes, Salisbury, Wiltshire (GB); Matthew Robinson, Salisbury, Wiltshire (GB)

(21) Appl. No.: 17/427,905

(22) PCT Filed: Feb. 21, 2020
(86) PCT No.: PCT/GB2020/000018

§ 371 Date: Aug. 2, 2021

(30) Foreign Application Priority Data
Feb. 27, 2019 (GB) 1902620.2

(51) Int. Cl. H01Q 21/26; H01Q 25/00; H01Q 9/28; H01Q 21/20; H01Q 19/185; H01Q 19/10; H01Q 1/52; H01Q 1/24

(52) U.S. Cl. CPC H01Q 21/26; H01Q 25/004; H01Q 9/285; H01Q 1/246; H01Q 19/185; H01Q 19/108; H01Q 1/521; H01Q 21/205

(57) ABSTRACT

A dual polarised planar antenna (10) comprising first (12) and second (13) antenna elements having respective orthogonal polarisations, the antenna elements (12, 13) being arranged in a back-to-back configuration and fed directly by respective first and second antenna feeds (15), wherein the dual polarised planar antenna (10) further comprises a parasitic element (14) arranged between the antenna elements (12, 13) such that in-use the antenna feeds (15) are decoupled. Particularly suited to low profile antennas and compact antenna base stations. Also relates to a method of manufacture.

### TECHNICAL FIELD OF THE INVENTION

This invention relates to the field of planar antennas, in particular to planar antennas that provide dual linear polarisation.

### BACKGROUND TO THE INVENTION

The development of low-profile antennas has enabled wireless communications to become prevalent in modern society. Most telecommunications handsets now use planar antenna elements, and patch antennas have been integrated into body wearable garments and devices. Planar antenna elements have also transitioned into vehicle mounted applications including into collision avoidance and autonomous navigation systems, owing to their compact nature.

The wireless signal environment is however becoming ever more contested with transmissions, with the demands on data transfer rates and bandwidth continually increasing. In an effort to meet these demands, additional communications ‘channels’ are being implemented in wireless communication systems through use of spatially separated or dual polarised antennas. This can however come at the expense of increasing antenna size, and in many applications there is limited physical space for accommodating such additional capabilities.

Antennas that do provide dual linear polarisation offer two independent communications channels at the same frequency. A dual polarised antenna may be manufactured using multiple antenna elements, however mutual coupling can exist between antenna feeds if these elements are closely spaced. This has made low-profile compact antennas difficult to manufacture.

Therefore it is an aim of the present invention to provide a dual polarised planar antenna that mitigates these issues.

### SUMMARY OF THE INVENTION

According to a first aspect of the invention there is provided a dual polarised planar antenna comprising first and second antenna elements having respective orthogonal polarisations, the antenna elements being arranged in a back-to-back configuration and directly fed respectively by first and second antenna feeds, wherein the dual polarised planar antenna further comprises a parasitic element arranged between the antenna elements, such that in-use the antenna feeds are decoupled from each other. By providing a parasitic element between the antenna elements the coupling between antenna feeds can be reduced. This allows the antenna elements to be positioned closer together than provided for in the prior art, thereby achieving a more compact antenna for space constrained applications. This is particularly advantageous at telecommunications frequencies (2G, 3G, 4G,—frequencies) for which antenna base stations have conventionally been spatially large. The antenna designs may also be suited to future 5G frequency bands.

The dual polarised planar antenna extends substantially in a plane. The antenna is intended to be compact, owing to the back-to-back configuration and close proximity of the antenna elements. The antenna elements have orthogonal linear polarisations, as may be achieved by rotating one of the antenna elements to be orthogonal relative to the other, for instance.

The parasitic element is arranged between the antenna elements when they are in the back-to-back configuration. Therefore the term ‘back-to-back’ is used to describe the arrangement of one element being adjacent the other, and the relative proximity of the antenna elements to each other, but does not necessitate the antenna elements being in physical contact. The parasitic element is a conductive—for instance metallic—element, and dimensioned to absorb electromagnetic radiation of a predetermined frequency or set of frequencies. When one of the antenna elements is transmitting, or indeed receiving, the transmitted or received signal may couple into the feed of the second antenna element. This is despite the antenna elements operating at orthogonal linear polarisations. The inventor has shown that a parasitic element arranged between the antenna elements can preferentially absorb the radiation that would otherwise be cross-coupled, thereby allowing antenna elements to be arranged with minimal separation in a back-to-back arrangement.

In preferred embodiments, the parasitic element is sandwiched between the two antenna elements. The term ‘sandwiched’ being used to describe the parasitic element being in abutment between the antenna elements. This minimises the depth profile of the antenna element, allowing use in highly space constrained environments such as within mobile phone handsets.

In some embodiments, the parasitic element consists of a single substantially annular element. The term ‘substantially annular’ includes parasitic elements that do not form a complete ring or circular shape. Whilst a split ring resonator may be used as a parasitic element, a single annular element contributes less capacitance to the planar antenna, and therefore causes less detuning than would be caused by a larger split ring resonator. The annular nature of the parasitic element ensures that radiation in both orthogonal linear polarisations is absorbed.

It is preferable that the antenna elements are themselves planar, to achieve an optimal low profile design. Even more preferable therefore is that the antenna elements are printed circuit board (PCB) antenna elements. PCB antenna elements can be readily manufactured using current circuit board printing techniques and can be tailored to have specific antenna structures to suit a given application.

In some embodiments comprising planar antenna elements, each antenna element comprises a dipole antenna. A dipole antenna is an omnidirectional antenna. In these embodiments the dual polarised planar antenna can be used as an omnidirectional antenna or can be used as a directional antenna with a suitable antenna back plate. Even more preferable is that the radiating arms of the dipole antennas are orthogonal to each other. This achieves the effect of providing dual polarisation. Furthermore, the inventor has shown that a dipole antenna can be readily manufactured onto a PCB.

In certain embodiments comprising planar antenna elements, the antenna elements further comprise parasitic radiating elements. These additional radiating elements may be etched into the same PCB as the main antenna design, for instance. The use of parasitic radiating elements further increases the bandwidth of the antenna elements. It is even more preferable that a plurality of parasitic radiating elements is provided on each planar antenna.

Preferably in embodiments comprising planar antenna elements, each antenna element comprises a dog-leg feed. For antenna elements in close proximity and particularly in a back-to-back configuration, accessing the antenna structures for powering can be difficult. This is because of limited space between the antenna elements. A strip line feed may be used, but back-to-back strip lines would be required to feed back-to-back elements whose feeds points are located in similar positions. This increases the overall thickness of the antenna because the feeds are parallel and overlap, which is undesirable for space constrained applications. The inventor has implemented a dog leg design such that the feed points of the antenna elements to not overlap, thereby mitigating this issue. Even more preferable is that the parasitic element is arranged between the dog-leg feeds of the antenna elements, so as to minimise coupling between the feeds.

Some embodiments of the dual polarised planar antenna further comprise a main antenna back plate arranged adjacent the antenna elements. The use of a back plate provides directionality to the antenna when omnidirectional antenna elements are used. The main antenna back plate is therefore intended to be reflective to radiation transmitted or received with the antenna elements, and therefore may comprise metal. Even more preferred is that the main antenna back plate comprises a centre plate and two angled wing plates. The centre plate is arranged to be parallel to the plane of the antenna elements, with the two angled wing plates being at an angle to the back-plate. This allows each dual polarised planar antenna to be mounted against two other similar antennas about a central axis so as to form a compact base station antenna. The angle between the centre plate and wing plates of the main antenna back plate is preferably 150 degrees such that three antennas of this embodiment can be mounted against each other to form such a compact base station antenna arrangement purposefully radiating away from a central axis.

Some embodiments comprising a main antenna back-plate may further comprise an intermediate back-plate arranged between the main antenna back-plate and the antenna elements. The intermediate back-plate may be mounted upon non-conductive pillar mounts. The distance of the intermediate back-plate from the antenna elements may be set so as to effectively reflect particular frequencies of radiation. The intermediate back-plate is intended to be spatially smaller than the main antenna back-plate.

According to a second aspect of the invention there is provided a base station, comprising a plurality of the dual polarised planar antennas of the first aspect of the invention, the dual polarised planar antennas being arranged in a substantially equidistant distributed array around a central axis, such that in-use the dual polarised planar antennas provide combined dual-polarised omnidirectional performance directed away from the central axis. Base stations, particularly indoor base stations for telecommunications, are inherently large owing to the size and spatial separation of the antennas forming the base station. By using the dual polarised planar antennas of the first aspect of the invention, the overall size of a base station can be reduced. The dual polarised planar antennas may be configured such that each respective antenna pattern combines with that of its neighbours in the base station to deliver overall omnidirectional performance. This provides communications performance for 360 degrees around the central axis, in two polarisations. Such a base station may be used to provide increased bandwidth for data transmission, or improved transmission/receipt performance in a multipath environment. Preferred embodiments of the second aspect of the invention further comprise powering means for powering the dual polarised planar antennas in-phase with each other, such that the communications can be made omnidirectionally for both polarisations, simultaneously.

According to a third aspect of the invention there is provided the use of a parasitic element to decouple antenna feeds of respective back-to-back antenna elements having orthogonal linear polarisations. An issue with close proximity antenna elements is cross coupling between antenna feeds, particularly during simultaneous operation. This makes operation of antenna elements in a back-to-back arrangement difficult. The inventor has shown a parasitic element can be used with back-to-back antennas to decouple the antennas sufficiently to allow successful operation. Preferably the parasitic element consists of a single substantially annular parasitic element which has been shown to contribute a reduced overall capacitance to an antenna compared to other parasitic element designs, thereby minimising antenna detuning.

According to a fourth aspect of the invention there is provided a method of manufacturing a dual polarised planar antenna, comprising the steps of arranging first and second antenna elements having orthogonal linear polarisations in a back-to-back configuration; providing respective first and second antenna feeds as direct feeds to the antenna elements; and arranging a parasitic element between the antenna elements, such that in-use the antenna feeds are decoupled. Preferably the parasitic element consists of a single substantially annular parasitic element.

The dual polarised planar antenna may be mounted upon a vehicle, operable in transmit or receive, or both, and orientated to direct radiation away from the vehicle. There may be a plurality of such antennas arranged around a vehicle to provide an overall omnidirectional coverage. Such an array of antenna elements may be operated in phase with each other, and may be arranged to be equidistant around a vehicle.

The feeds to the antenna elements are direct connections, and for physical stability may be implemented as stripline baluns. Tapered baluns may be used to support wideband operation.

### BRIEF DESCRIPTION OF THE DRAWINGS

Embodiments of the invention will now be described by way of example only and with reference to the accompanying drawings, in which:

FIG. 1a illustrates in cutaway plan view an embodiment of a dual polarised planar antenna with a parasitic element;

FIG. 1b illustrates in cutaway plan view the arrangement of the parasitic element in FIG. 1a;

FIG. 2a illustrates in perspective view an embodiment of a base station antenna; and

FIG. 2b illustrates in plan view the base station antenna of FIG. 2a.

### DETAILED DESCRIPTION

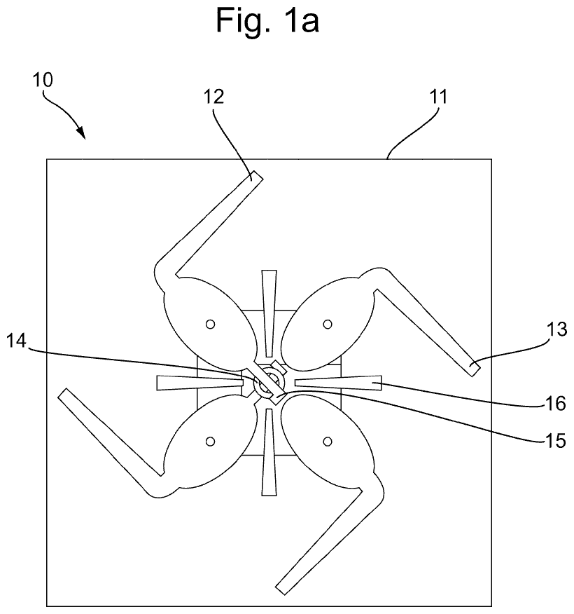

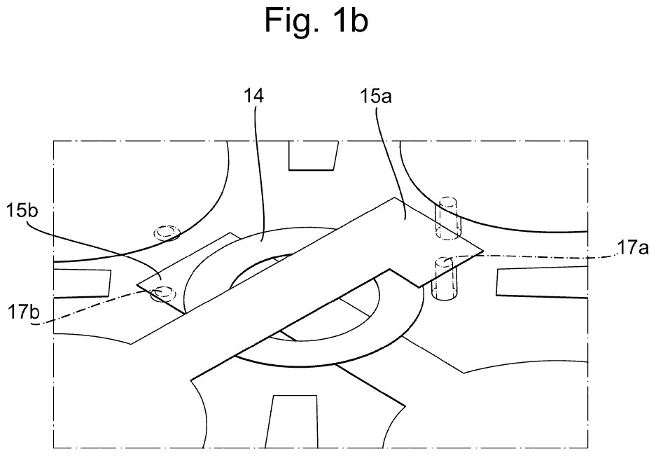

FIG. 1a illustrates in cutaway plan view an embodiment of a dual polarised antenna 10. The dual polarised antenna 10 is a planar antenna comprising a square printed circuit board 11. A first dipole antenna 12 is printed on one side of circuit board 11. A second dipole antenna 13 is printed on an opposing side of circuit board 11. Each dipole (12, 13) is 116 mm in length, measured linearly between the outer periphery of the radiating arms. The figure shows the circuit board 11 being semi-transparent for indicative purposes only. The dipole antennas (12, 13) are shown as having 90 degree relative rotation about a central axis perpendicular to the circuit board 11. This achieves respective orthogonal linear polarisations. At the centre of the dipoles (12, 13) are respective dog leg feeds 15. The feeds 15 are directly connected to the radiating elements of the dipoles (12, 13). Between the feeds 15 there is a parasitic element 14. The parasitic element is annular having a 11 mm diameter and is formed from metal. Additional radiators 16 are also present on both opposing sides of the circuit board 11. The additional radiators 16 have a length of 30 mm. The multi-sectored element array has two distinct isolated radiating elements providing an overall multi-channel performance.

FIG. 1b illustrates in cutaway plan view the dual polarised planar antenna 10 of FIG. 1a, zoomed to depict the arrangement of the parasitic element 14. The dog leg feeds 15a and 15b of the first and second dipole antennas (12, 13) are shown adjacent each other, but rotated 90 degrees to each other. The dog legs 15a and 15b can therefore be interfaced with separately at locations 17a and 17b respectively. The annular parasitic element 14 is shown sandwiched between the feeds 15a and 15b to mitigate coupling.

In use the dual polarised planar antenna 10 is fed using dog leg feeds 15a and 15b. The orthogonal spatial orientations of dipoles 12 and 13 results in the transmitted radiation from each dipole (12, 13) having a different linear polarisation. Radiation that would normally electromagnetically couple between the feeds 15a and 15b is absorbed by the parasitic element 14. This allows for two channels of simultaneous transmission whilst minimising artefacts of a signal transmitted from one dipole (12, 13) antenna coupling across to the transmission from the other (13, 12). A similar benefit is achieved from the dipole antennas (12, 13) are operated in receive.

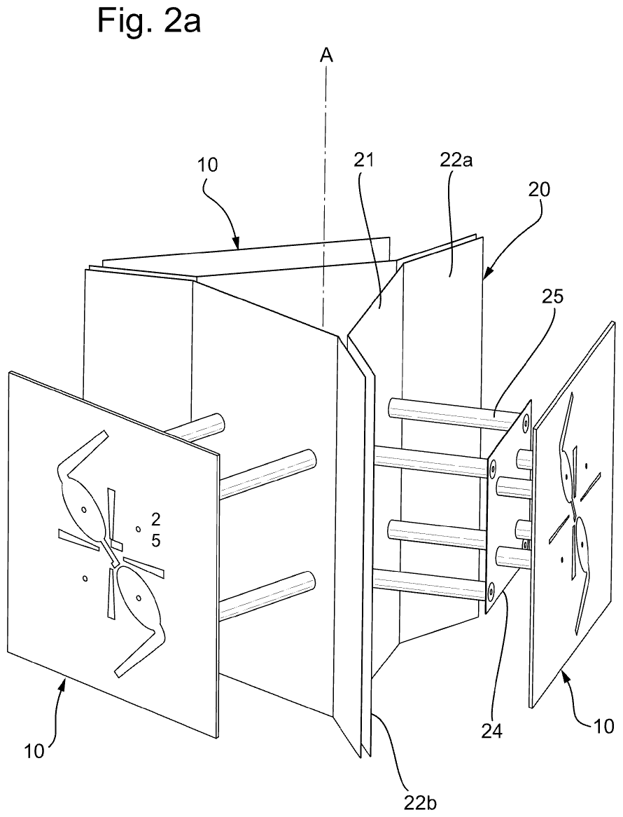

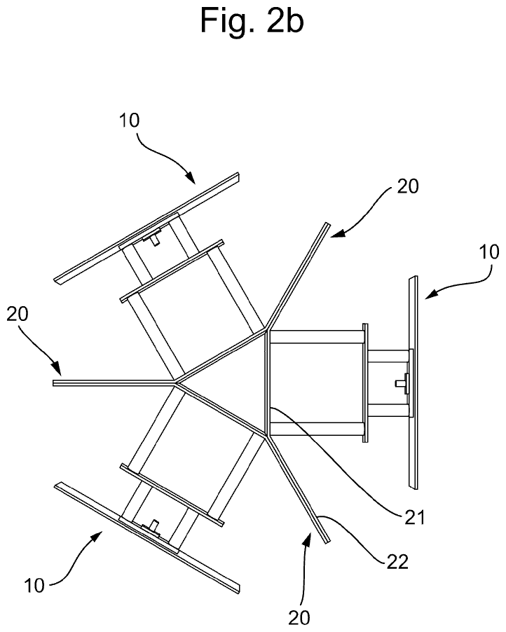

FIG. 2a illustrates in perspective view dual polarised planar antennas 10 arranged as a base station around a central axis ‘A’. A total of three planar antennas 10 are shown positioned adjacent respective main back plates 20. Intermediate each main back plate 20 is an intermediate back plate 24. Each planar antenna and respective main 20 and intermediate 24 back plates are fixed relative to each other using non-conductive pillar mounts 25. The distance between an antenna 10 and its respective main back plate 20 is 120 mm. The distance between an antenna 10 and its respective intermediate back plate 20 is 40 mm. The intermediate back plate 24 measures 90 mm x×90 mm and is spatially smaller than the main back plate 20. The main back plates 20 comprise a central plate 21 and two wing plates 22a and 22b. The total width of each main back plate is 260 mm, measured between the respective ends of the wing plates 22a and 22b. The central plate 21 is parallel to the respective planar antenna 10, whereas the wing plates 22 are angled thereto. All the back plates (20, 24) are formed from metal.

FIG. 2b further illustrates the base station shown in FIG. 2a in plan view. The dual polarised planar antennas 10 are shown adjacent their respective main back plates 20, forming a total of three directional antennas. The main back plates 20 are able to abut each other to form a spatially compact base station, owing to the angling of the wing plates 22. The wing plates 22 in this embodiment are angled relative to the central plate 21 by 150 degrees. The base station therefore comprises an array of directional antennas that radiate away from the central axis ‘A’ in a combined omnidirectional manner.

In use each dual polarised antenna 10 transmits from both its respective dipole antennas (12, 13), each dipole antenna (12, 13) transmitting with a different linear polarisation. Radiation transmitted towards the main back plate 20 and intermediate back plate 24 is reflected, giving each dipole antenna a directional radiation pattern. The distances between the main back plate 20 and intermediate back plate 24 can be configured for particular frequencies (for instance the intermediate back plate 24 may be used to define cavity back plate for higher frequencies than the main back plate 20. The radiation patterns from each dual polarised antenna 10 with respective back plates (20, 24) can be configured to overlap to provide high gain omnidirectional performance radiating away from central axis A. This provides a high gain omnidirectional base station simultaneously operable at two orthogonal polarisations, with a compact design. The described base station may operate at frequencies between 600 MHz and 3.4 GHz, but with an overall diameter of approximately 160 mm.

Whilst the embodiments show printed dipole antennas, this is not intended to be limiting. Other antenna designs can be configured in a back-to-back arrangement and operated with two polarisations if a parasitic element is arranged between the antenna feeds. In addition, a base station may be designed with an alternative number of antenna elements if the wing plates of the main back plates are angled differently. The dual polarised antennas may be operated in phase, but may additionally be used to provide angular diversity to the base station. A plurality of base station antennas may be attached together so as to provide increased bandwidth. For instance a first base station antenna may be used for covering 2G, 3G and 4G frequencies, with a second base station antenna attached to the first base station antenna, optionally providing additional 5G frequency coverage. The base station antennas may be vertically mounted to each other so as to not obstruct their respective omnidirectional performances.

1. A dual polarised planar antenna comprising first and second antenna elements having respective orthogonal polarisations, the antenna elements being arranged in a back-to-back configuration and fed directly by respective first and second antenna feeds, wherein the dual polarised planar antenna further comprises a parasitic element arranged between the antenna elements, such that in-use the antenna feeds are decoupled.

2. The dual polarised planar antenna of claim 1, wherein the parasitic element is sandwiched between the antenna elements.

3. The dual polarised planar antenna of claim 1, wherein the parasitic element consists of a single substantially annular parasitic element.

4. The dual polarised planar antenna of any one of claim 1, wherein the antenna elements are planar antenna elements.

5. The dual polarised planar antenna of claim 4, wherein the antenna elements are printed circuit board antennas.

6. The dual polarised planar antenna of any one of claim 4, wherein each of the antenna elements comprises a dipole antenna.

7. The dual polarised planar antenna of claim 6, wherein the dipole antennas have orthogonal radiating arms.

8. The dual polarised planar antenna of claim 4, wherein the antenna elements further comprise parasitic radiating elements.

9. The dual polarised planar antenna of claim 4, wherein each planar antenna element comprises a dog-leg feed.

10. The dual polarised planar antenna of claim 9, wherein the parasitic element is arranged between the dog-leg feeds.

11. The dual polarised planar antenna of claim 1, further comprising a main antenna back plate arranged adjacent the antenna elements.

12. The dual polarised planar antenna of claim 11, wherein the main antenna back plate comprises a centre plate and two angled wing plates.

13. The dual polarised planar antenna of claim 12, wherein the wing plates are angled at 150 degrees to the centre plate.

14. The dual polarised planar antenna of claim 11, further comprising an intermediate back plate arranged between the main antenna back plate and the antenna elements.

15. The dual polarised planar antenna of claim 1, mounted upon a vehicle.

16. A base station antenna, comprising a plurality of the dual polarised planar antennas of claim 11, the dual polarised planar antennas being arranged in a substantially equidistant distributed array around a central axis, such that in-use the dual polarised planar antennas provide combined dual-polarised omnidirectional performance directed away from the central axis.

17. The base station antenna of claim 16, further comprising powering means for powering the dual polarised planar antennas in-phase with each other.

18. Use of a parasitic element to decouple antenna feeds of respective back-to-back antenna elements having orthogonal linear polarisations.

19. The use of claim 18, wherein the parasitic element consists of a single substantially annular parasitic element.

20. A method of manufacturing a dual polarised planar antenna, comprising the steps of:
a) Arranging first and second antenna elements having orthogonal linear polarisations in a back-to-back configuration;
b) Providing respective first and second antenna feeds as direct feeds to the antenna elements; and then
c) Arranging a parasitic element between the antenna elements;
such that in-use the antenna feeds are decoupled.

21. The method of claim 20, wherein the parasitic element consists of a single substantially annular parasitic element.
